(19) United States
(12) Patent Application Publication
(10) Pub. No.: US 2010/0072932 A1
(43) Pub. Date: Mar. 25, 2010

(54) Fail-Passive Electro-Mechanical Actuator Utilizing Dual Controllers And A Two-Phase Brushless Motor

(76) Inventors: Eric Seger, Bozeman, MT (US); Gary L. Frederick, Byron, IL (US); Richard A. Rose, Rockford, IL (US); Jerry D. Hielkema, Rockton, IL (US)

Correspondence Address: CHRISTIE, PARKER & HALE, LLP, PO BOX 7068, PASADENA, CA, 91109-7068, US

(21) Appl. No.: 12/512,967

(22) Filed: Jul. 30, 2009

Related U.S. Application Data
(60) Provisional application No. 61/085,413, filed on Jul. 31, 2008.

(51) Int. Cl. H02P 6/12; H02K 3/28

(52) U.S. Cl. 318/490; 310/195

(57) ABSTRACT

A fail-passive electro-mechanical actuator utilizing dual controllers and a two-phase brushless motor is provided. In one embodiment, the invention relates to a fail passive system for controlling a two phase brushless motor, the system including the two phase brushless motor including a stator, a rotor, a first winding electromagnetically coupled to the rotor, and a second winding electromagnetically coupled to the rotor, first control circuitry coupled to the first winding, the first control circuitry configured to provide a first current to the first winding, second control circuitry coupled to the second winding, the second control circuitry to provide a second current to the second winding, wherein the first control circuitry is configured to receive a first commanded value from an external control circuit, wherein the second control circuitry is configured to receive a second commanded value from the external control circuit, wherein the first control circuitry is configured to receive a negated form of the second commanded value from the second circuitry, wherein the second control circuitry is configured to receive a negated form of the first commanded value from the first circuitry, and wherein the first control circuitry and the second control circuitry are configured to concurrently control a movement of the rotor.

### CROSS REFERENCE TO RELATED APPLICATIONS

The present application claims the benefit of Provisional Application No. 61/085,413, filed Jul. 31, 2008, entitled “A FAIL-PASSIVE ELECTRO-MECHANICAL ACTUATOR UTILIZING DUAL CONTROLLERS AND A TWO-PHASE BRUSHLESS MOTOR”, the entire content of which is expressly incorporated herein by reference.

### BACKGROUND OF THE INVENTION

Fail-safe autopilot servo actuators have traditionally used brushed DC motors with dual lane servo amplifiers and tachometers. In such systems, each lane controls the voltage at one motor terminal. Because each lane implements its own closed loop control, the functioning lane automatically adjusts to a failure in the opposite lane without directly detecting the failure in the opposite lane. This smart servo architecture provides self-compensating dual lane control of the motor while allowing local electronics to provide the servo loop closure. Interfacing equipment can control and monitor the servo actuator through a standard avionics bus protocol such as ARINC 429 digital data interfaces. Replicating these fail-passive features, where each of the two lanes have equal control of the motor, for a more reliable brushless motor would be beneficial.

### SUMMARY OF THE INVENTION

Aspects of the invention relates to a fail-passive electro-mechanical actuator utilizing dual controllers and a two-phase brushless motor. In one embodiment, the invention relates to a fail passive system for controlling a two phase brushless motor, the system including the two phase brushless motor including a stator, a rotor, a first winding electromagnetically coupled to the rotor, and a second winding electromagnetically coupled to the rotor, first control circuitry coupled to the first winding, the first control circuitry configured to provide a first current to the first winding, second control circuitry coupled to the second winding, the second control circuitry to provide a second current to the second winding, wherein the first control circuitry is configured to receive a first commanded value from an external control circuit, wherein the second control circuitry is configured to receive a second commanded value from the external control circuit, wherein the first control circuitry is configured to receive a negated form of the second commanded value from the second circuitry, wherein the second control circuitry is configured to receive a negated form of the first commanded value from the first circuitry, and wherein the first control circuitry and the second control circuitry are configured to concurrently

In another embodiment, the invention relates to a method for controlling a two phase brushless motor system including a rotor, a stator having a first winding and a second winding, a first control circuitry for controlling a movement of the rotor by providing a first current to the first winding, and a second control circuitry for controlling the movement of the rotor by providing a second current to the second winding, the method including receiving, at the first circuitry, a first commanded value, receiving, at the second circuitry, a second commanded value, receiving, at the first circuitry, a negated form of the second commanded value, receiving, at the second circuitry, a negated form of the first commanded value, selecting, at the first circuitry, a first value, based on a first preselected criteria, from a group consisting of the first commanded value, the negated second commanded value and a first default value, selecting, at the second circuitry, a second value, based on a second preselected criteria, from a group consisting of the negated first commanded value, the second commanded value and a second default value, generating the first current, based on the first value, for the first winding, generating the second current, based on the second value, for the second winding.

### BRIEF DESCRIPTION OF THE DRAWINGS

FIG. 1 is a schematic block diagram of a motor control system including a two phase brushless motor and a dual lane control system in accordance with one embodiment of the invention.

FIG. 2 is a lengthwise sectional view of a two phase brushless motor in accordance with one embodiment of the invention.

FIG. 3 is a cross sectional view of the two phase brushless motor of FIG. 2 illustrating the alignment of the rotor, the stator, and stator windings in accordance with one embodiment of the invention.

FIG. 4 is a schematic diagram of the coils for one stator winding in accordance with one embodiment of the invention.

FIG. 5 is a flowchart illustrating a high level process for controlling a two phase brushless motor system in accordance with one embodiment of the invention.

FIG. 6 is a flowchart illustrating a process for controlling a two phase brushless motor in accordance with one embodiment of the invention.

FIG. 7 is a flowchart illustrating a sequence of exemplary operations for a brushless motor control system in accordance with one embodiment of the invention.

FIG. 8 is a flowchart illustrating steady state conditions for a brushless motor control system in accordance with the operational sequence of FIG. 7.

FIG. 9 is a flowchart illustrating a process for receiving parameters via ARINC for a brushless motor control system in accordance with the operational sequence of FIG. 7.

FIG. 10 is a flowchart illustrating a process for engaging the clutch for a brushless motor control system in accordance with the operational sequence of FIG. 7.

FIG. 11 is a flowchart illustrating a main process for determining PWM values for a brushless motor control system in accordance with the operational sequence of FIG. 7,

FIG. 12 is a flowchart illustrating a sub-process for determining an output of a mid-value select algorithm of the process for determining PWM values illustrated in FIG, 11.

FIG. 13 is a flowchart illustrating a sub-process for determining torque in conjunction with the process for determining PWM values illustrated in FIG. 11.

FIG. 14 is a flowchart illustrating a sub-process for determining acceleration in conjunction with the process for determining PWM values illustrated in FIG. 11.

FIG. 15 is a flowchart illustrating a sub-process for determining a PWM value in conjunction with the process for determining PWM values illustrated in FIG. 11.

FIG. 16 is a schematic block diagram illustrating of a mid-value select system in accordance with one embodiment of the invention.

FIG. 17 is a flowchart illustrating a process for substantially independent control of a two phase brushless motor with first circuitry controlling a first winding of the motor and second circuitry controlling a second winding of the motor in accordance with one embodiment of the invention.

### DETAILED DESCRIPTION

Embodiments of a brushless motor control system control a two phase brushless motor. In many embodiments, the control system includes first control circuitry for controlling one stator winding of the motor and second control circuitry for controlling a second stator winding. The first circuitry and second circuitry operate substantially independent of one another. However, they do share commanded value information in a negated form so that the information cannot be misused by either control circuitry. In several embodiments, the first circuitry and the second circuitry each use a mid-value select function to avoid transients, faults, or lags associated with certain input values. The brushless motor can include a four pole rotor and stator windings that each include four coils wound in opposite directions to minimize uncommanded motion, provide maximum efficiency and motor control.

Embodiments of brushless motor systems can provide two-phase construction for simple vector control which often translates to smooth operation with minimum poles, provide sinusoidal torque production, and provide a two winding motor with substantially isolated control drive electronics to eliminate runaways for drive circuit failures.

Embodiments of the brushless motor systems, or smart servo actuator, can be used as part of a digital autopilot system to be used on Part 25 commercial aircraft. The smart servo actuator can be fail-passive such that no single fault results in uncommanded motion greater than 1.5 degrees at the capstan. This can be accomplished using a unique, two phase brushless DC (BLDC) motor, and independent dual-lane DSP controllers with associated redundant sensors, monitors and software as described below. The actuator safety features also include an electromagnetic engage clutch which can be disengaged independently by either controller or by remotely removing the clutch power input.

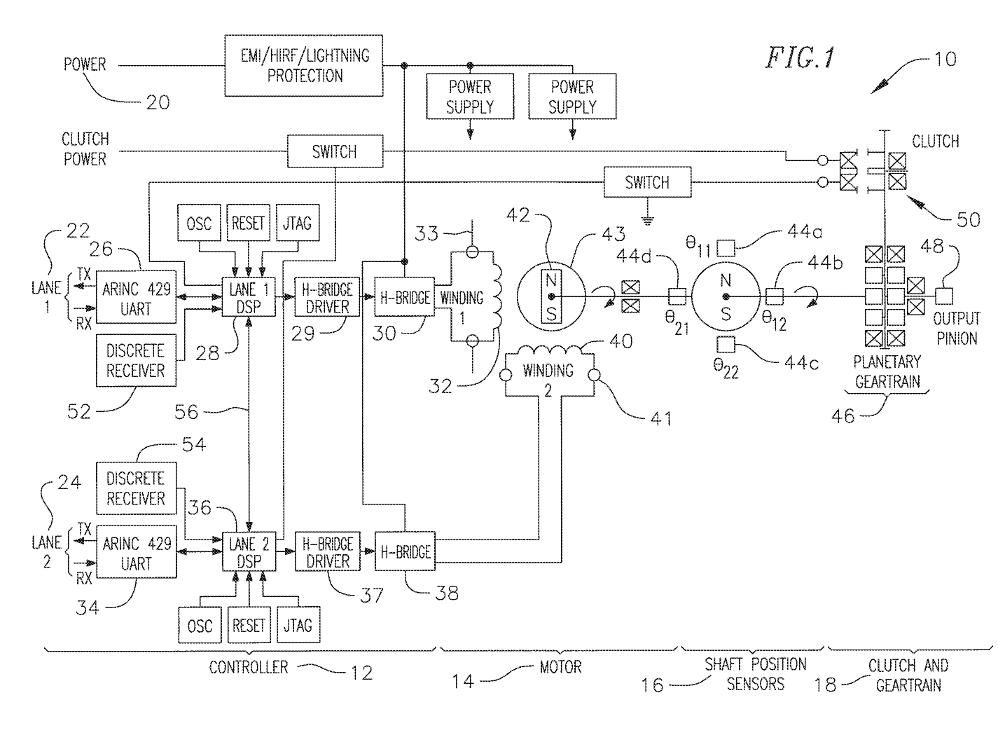

FIG. 1 is a schematic block diagram of a motor control system 10 including a dual lane control system 12 and a two phase brushless motor 14 in accordance with one embodiment of the invention. The motor control system 10 further includes motor/shaft position sensors 16, a clutch and gear train 18, and a power supply 20.

The dual lane control system 12 includes first lane circuitry 22 and a second lane circuitry 24. The dual control lanes (22, 24) can operate substantially independent from one another, where each lane has individual control over the two phase motor 14. The first lane 22 includes a ARINC 429 universal asynchronous receiver/transmitter (UART) 26 for receiving information such as commands from a flight computer (not shown). The UART 26 is coupled to a digital signal processor (DSP), or lane one control circuitry, 28. The UART 26 can include registers for particular UART modes controlled by logic signals generated by the lane one DSP 28. The UART 26 can generally include FIFO buffers to prevent overrun errors. The lane one DSP 28 is coupled to an H-Bridge driver 29 for amplifying a pulse width modulated (PWM) output of DSP 28. The H-Bridge driver 29 is coupled to H-Bridge circuitry 30 that provides bi-directional control of the current provided to a first winding 32. The first winding 32 can include a number of coils that are in electromagnetic communication with the rotor 42 of the motor. In a number of embodiments, the first winding 32 is a component of a stator 43 for the motor.

The second lane 24 includes a ARINC 429 UART 34 for receiving information such as commands from a flight computer (not shown). The UART 34 is coupled to a digital signal processor (DSP), or lane two control circuitry, 36. The UART 34 can include registers for particular UART modes controlled by logic signals generated by the lane two DSP 36. The UART 34 can generally include FIFO buffers to prevent overrun errors. The lane two DSP 36 is coupled to an H-Bridge driver 37 for amplifying a PWM output of DSP 36. The H-Bridge driver 37 is coupled to H-Bridge circuitry 38 that provides bi-directional control of the current provided to a second winding 40. The second winding 40 can include a number of coils that are in electromagnetic communication with the rotor 42 of the motor. In a number of embodiments, the second winding 40 is a component of the stator 43 for the motor.

Four position sensors (44a, 44b, 44c, 44d) are positioned at points surrounding the rotor/motor shaft. At an end of the rotor/motor shaft, the motor system includes a planetary gear train 46 followed by the output pinion 48. Engagement of the planetary gear train 46 can be controlled by a clutch 50. The clutch 50 can be independently controlled by the lane one DSP 28 and lane two DSP 36.

In some embodiments, the brushless motor system is referred to as a smart servo actuator. The smart servo actuator can contain all of the components and software necessary to complete motor control loops and monitor servo integrity. Servo commands and instructions are provided to each lane of the servo in using the ARINC 429 high speed format. Position, rate, or torque commands can be accepted by the controller depending on instructions provided to the servo. Message structure can be coordinated with an autopilot system to ensure the integrity of the data received by each lane. Smart servo position, speed, torque data and status can also be transmitted to interfacing equipment in the ARINC 429 high speed format. Hardware interface to the controllers is accomplished using the ARINC 429 UARTs in each lane. Addressing for each lane of the smart servo can be achieved using discretes (52, 54) that are hard-wired during the installation. In other embodiments, other means for addressing the smart servo can be used.

The motor 14 is a two-phase, four-pole BLDC motor specifically designed for fail passive autopilot applications. The rotor assembly includes a number of rare earth magnets attached to a rotor, output gear, and sensor magnet assembly. The motor stator includes two independent windings (32, 40). The current in each winding is independently controlled by either of the controllers. The motor torque is provided by the vector sum of the currents in the two windings. The amplitude of the current vector is proportional to the output torque. The current vector leads the pole position of the rotor by 90 degrees in the direction of the desired torque or rotation. Each winding can have two current sensors (33, 41) provided at each end of the stator windings. One current sensor can be used for independent control and the other for independent monitoring by the opposite lane's controller.

Rotor angular position is sensed by using a pair of linear ratiometric Hall-effect sensors (44a, 44b, 44c, 44d) located radially around a four-pole sensor magnet attached directly to the motor shaft. Sensor output voltage pairs are provided to the DSP controller's analog to digital converters, where the rotor angle is calculated as the arctangent of the voltage ratio. Each lane has dedicated position sensors and independently calculates rotor position from its sensor inputs. Rotor position is used to determine the correct level of current in a particular lane's motor coil, calculate delta position, and compute shaft angular rate of rotation.

In the embodiment illustrated in FIG. 1, the controllers are dissimilar DSP microcontrollers (28, 36) designed specifically for motor control. One lane DSP is a Texas Instruments (TI) TMS320F2800 series DSP and the second lane is a Freescale 56F8300 series DSP (Texas Instruments and Freescale are trademarks of those companies). In other embodiments, other controller models can be used. In one embodiment, the controllers are identical. Each processor receives independent commands via the corresponding lane's ARINC 429 data bus. The address of the smart servo can be determined by reading input discretes (52, 54) that are hard-wired into the installation. The DSPs (28,36) will respond to messages that match the hard-wired address,

Command message structure, reasonableness, and freshness are examined to ensure integrity. Reasonableness can refer to checks to confirm that the incoming messages are uncorrupted before they reach the servo and that data fields of those messages are within a preselected range. This is accomplished by performing a cyclical redundant check (CRC) over the messages. Freshness can refer to the servo receiving messages at a particular rate (e.g., 100 Hz). If messages are not received within this time frame, this can trigger flag indicative of a fault condition forcing the clutch to disengage. Processing of command and sensor inputs to produce a motor coil current command is performed at high speed with current modulation being achieved utilizing a pulse width modulation (PWM) feature integral to the DSPs. Each controller includes a number of sensor inputs, including inputs for current in the controller's windings, current in the other controller's windings, clutch current, supply voltage, internal power supply voltage and position of the rotor. The PWM signal is used to switch MOSFET pairs in a conventional H-bridge (30, 38).

The operation of the motor to produce a desired torque and speed generally requires the proper current in each stator winding (33, 40) as determined independently by its lane's command signal, sensor inputs, and computed current.

A failure in either lane due to a shorted or open stator coil, shorted or opened power MOSFETs, or erroneous switching commands will generally result in a maximum movement of the motor rotor of 90 degrees. A BLDC motor is inherently safe to the extent that the coils must be actively controlled for continued motion. Such a motor generally cannot move more than 90 degrees if the current through one of the coils is constant.

The output of the motor 18 drives a two-stage, 20 to 1 planetary gear reducer which further drives through a 5.85 to 1 spur gear reducer in the servo mount. This planetary gear reducer can provide the required output torque and speed. A description of a planetary gear that can be used in conjunction with the motor 14 is included in U.S. application Ser. No. 12/326,074, filed Dec. 1, 2008, entitled “HIGH RATIO GEAR REDUCER”, the entire content of which is expressly incorporated herein by reference. In the event of a worst case 90 degree hardover in motor rotor position, the upset at the capstan can be limited to less than 1.5 degrees.

The ring gear of the planetary gear system 18 is allowed to freewheel when the servo actuator clutch is disengaged. The ring gear is generally locked in radial position when the clutch is engaged. This is accomplished with a spur gear machined on the outside of the ring gear, which mates with a corresponding spur gear on the clutch pole assembly's outside diameter. When the clutch coil is energized, annular face gears on the pole faces are locked together to ground the ring gear and mechanically engage the servo actuator. The current signal to the clutch is a separate signal provided from the autopilot's controlling computer. MOSFET switches at each end of the clutch coil allow either lane of the actuator to independently disengage the clutch when a failure is detected by a controller via the monitors. Independent clutch current sensors are also provided at each end of the coil. These current signals are monitored by DSP controller and can be used for both closed loop PWM control of the clutch current by an individual lane and for monitoring by the opposite lane. These functions are alternated periodically to detect latent failures in the components that allow the clutch to be internally disengaged.

In addition to dual current and position sensors, each lane also includes a watchdog circuit to monitor DSP performance. Both DSPs independently monitor the power supply voltages. The Serial Peripheral Interface (SPI) bus 56 resident to each DSP is used for cross-checking of input commands, sensor data, monitor inputs, actuator output performance and other functions checked during built-in-testing. Disagreements in the cross-check process can result in the reporting of a fault condition via the ARINC 429 bus. Such disagreements or other faults can also initiate the disengagement of the clutch by the cross side DSP.

The controllers (28, 36) communicate with each other using the SPI bus. In several embodiments, each controller receives a negated form of the other controller's commanded value (e.g., cross-side command value) such as position. For example, if the lane one controller 28 has received a commanded value for a position of 10 degrees and the lane two controller 36 has received a commanded value for a position of 15 degrees, then the lane one controller 28 would receive a value −15 degrees and the lane two controller 36 would receive a value of −10 degrees. By sharing information in this way, the dual lane control system avoids use of true control information from either of the controllers, thereby preventing either controller from accepting the information of the other controller as being its own. Such considerations can be important in flight applications.

The brushless motor can be a slotless, brushless type motor. Most existing slotless brushless motors are 3-phase with three windings (6 coils). In a number of embodiments, the motor of the present invention is a combination of a four-pole rotor and two stator windings with four coils where each is positioned forty five degrees from each other. In other embodiments, a two-pole rotor can be used. In other embodiments, the stator contains two phases with two coils (one coil per phase) positioned 90 degrees from each other.

Depending on the design requirements for a specific application there can be any combination of stator coils and rotor poles. As the number of stator coils or rotor poles are increased, the cost of manufacturing increases while the output torque ripple decreases.

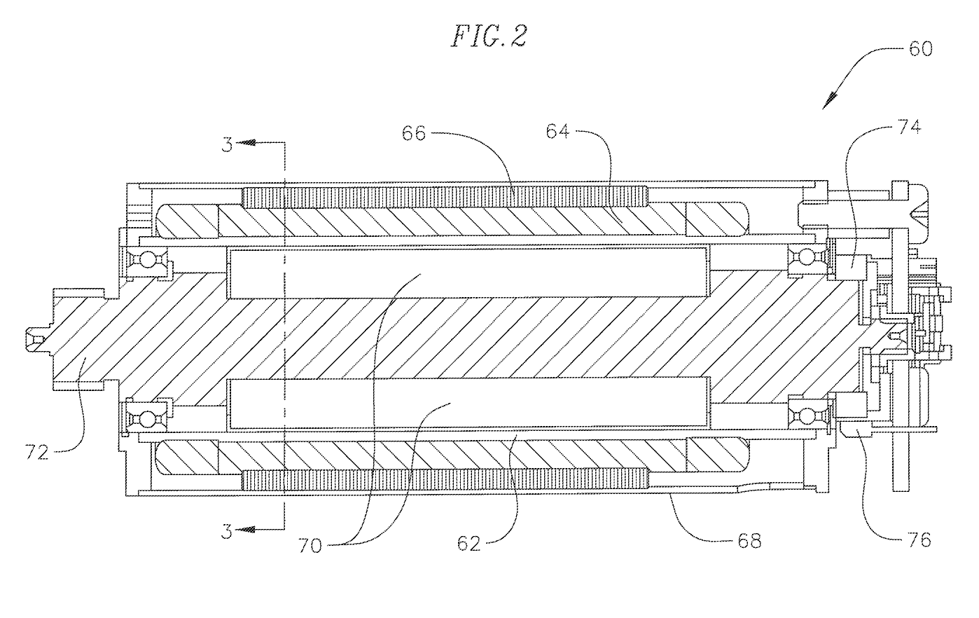

FIG. 2 is a lengthwise sectional view of a two phase brushless motor 60 in accordance with one embodiment of the invention. The stator construction contains a temperature resistant phenolic sleeve 62 to separate the windings 64 from the rotor, disc shaped laminations 66 to provide a magnetic return path and reduce eddy current losses, and a stainless steel housing 68 to enclose the motor. The rotor construction consists of four rare earth magnets 70 bonded to stainless steel shaft 72 surrounded by a Mylar tube that is heat shrunk in place. At the end of the shaft 72, a hall effect magnet 74 is used in conjunction with a hall effect sensor 76.

FIG. 3 is a cross sectional view of the two phase brushless motor of FIG. 2 illustrating the alignment of the rotor 42′, the stator 43, and stator windings (L1, L2) in accordance with one embodiment of the invention.

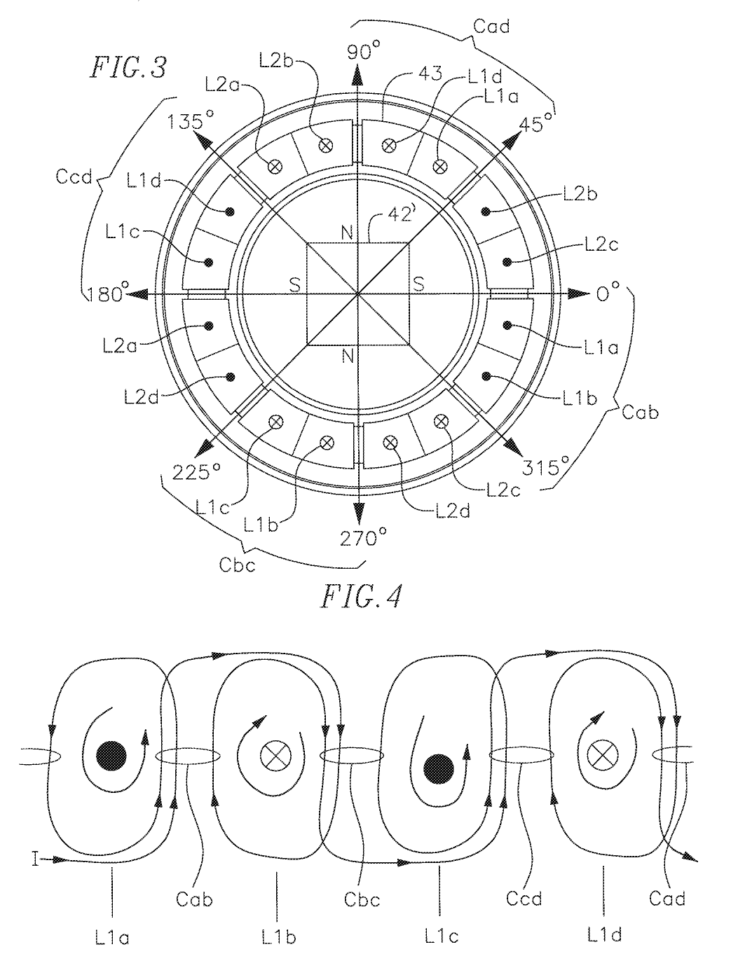

FIG. 4 is a schematic diagram of the coils for one stator winding L1 in accordance with one embodiment of the invention. In several embodiments, the stator winding L1 can be used with the two phase brushless motor of FIGS. 2 and 3. Each phase/winding consists of a series of four coils of a specified number of turns, with each coil in the winding series wound in the opposite direction from the adjacent coil. For example, the L1 stator winding includes coils L1a, L1b, L1e, and L1d, where L1b is wound in the opposite direction of L1a and L1c. Coil L1d is wound in the same direction as coil L1b. The L2 stator winding (see FIG. 3) is wound in a similar fashion, where L2b is wound in the opposite direction of L2a and L2c. Coil L2d is wound in the same direction as coil L2b.

Thus, the contribution of each turn on each coil adds to the contribution of every other coil in controlling the four pole rotor 42′. In other embodiments, a rotor having a different number of poles can be used. Proper orientation of the coils provides a sinusoidal output with low ripple torque.

To understand how the adjacent coils of FIG. 4 interact with each other, consider a voltage applied across the winding to produce a current (I). The arrows show the direction in which current (I) flows. Using a defined direction for current flow and the right hand rule, a direction of the magnetic field can be determined. With respect to coil L1a and coil L1c, for example, the magnetic field can extend into the page. With respect to coil L1b and coil L1d, the magnetic field can extend out of the page. So when current is flowing through the single stator winding, alternating magnetic fields are produced and the fields of adjacent coils in the winding series oppose each other.

Returning now to FIG. 3, the cross sectional view illustrates the layout of the stator coils of the stator 43 in relationship to the rotor 42′. The stator 43 is divided into eight half-quadrant sections each having a coil of one stator winding (L1 or L2) adjacent to another coil of the same stator winding. For example, from 0 to 45 degrees, the first half-quadrant section includes windings of a coil of the second winding L2c and windings of another coil of the second winding L2b. The windings of coils L2b and L2c in the first half-quadrant are directed into the page, as illustrated by the dot. The second half-quadrant section, from 45 to 90 degrees, includes windings of a coil of the first winding L1a and windings of another coil of the first winding L1d. The windings of coils L1a and L1d in the second half-quadrant are directed out of the page, as illustrated by the circled “X”. The remaining coils of the windings are similarly arranged in the other half-quadrant sections along the ring shaped stator 43.

Returning to FIG. 4, the current in the windings of adjacent coils of winding series L1 travels in the same direction at locations where the coil windings are coupled (Cab, Cbc, Ccd, Cad), or in close proximity. The coupled sections (Cab, Cbc, Ccd, Cad) are also illustrated in FIG. 3. The second winding L2 includes similar coils and coupled sections as the first winding L1.

When two stators windings are assembled together, a complete stator assembly is formed, as illustrated in FIG. 3. When all of the stator coils are taken into consideration, each winding, and corresponding DSP control circuitry, have control of in any of the four quadrants. The motor torque is provided by the vector sum of the currents in the two windings. The amplitude of the resultant current vector between the two stator windings is proportional to the output torque.

In the event of a failure in any of the components in either of the lanes controlled by the respective DSP controllers, the result can have a hardover effect on the motor. The control system described above, however, is designed to minimize any hardover effects by actively monitoring and responding to any such failures. In addition, the physical design of the stator windings and four pole rotor limit the worst case effect of a fault in the system. For example, in the event of a worst case 90 degree hardover in motor rotor position, the upset at the capstan can be limited to less than 1.5 degrees. A failure in either lane due to a shorted or open stator coil, shorted or opened power MOSFETs, or erroneous switching commands will generally result in a maximum movement of the motor rotor of 90 degrees. A BLDC motor is inherently safe to the extent that the coils must be actively controlled for continued motion. Such a motor generally cannot move more than 90 degrees if the current through one of the coils is constant.

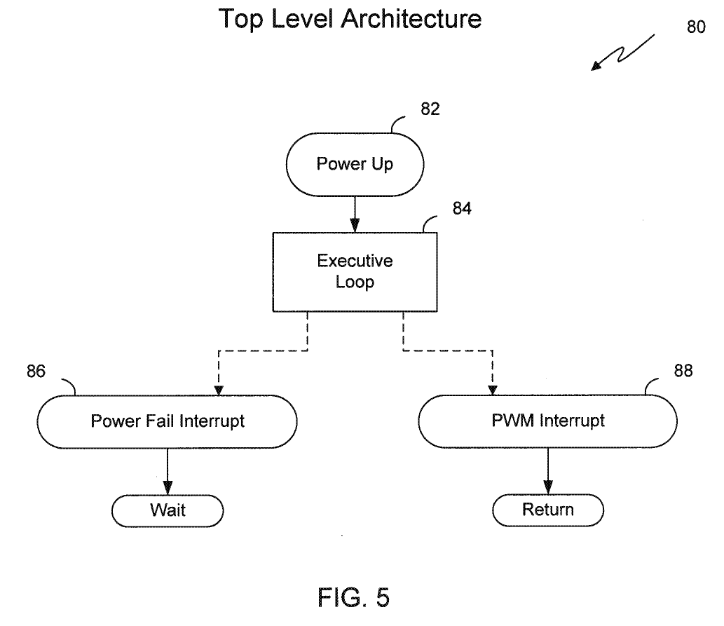

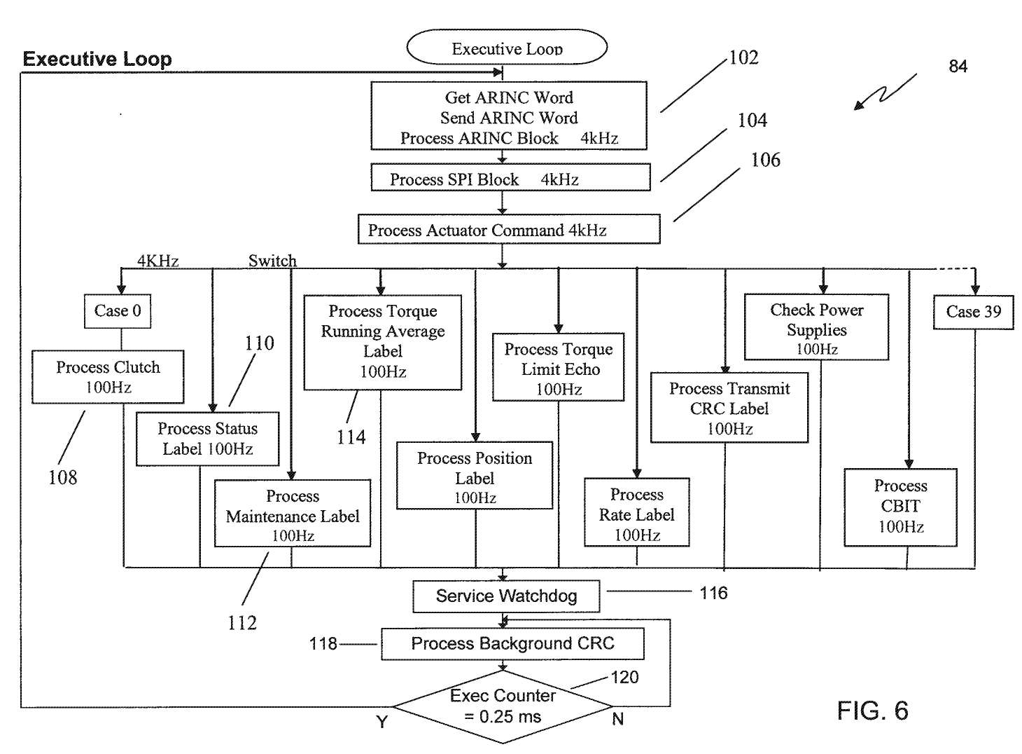

FIG. 5 is a flowchart illustrating a high level process 80 for controlling a two phase brushless motor system in accordance with one embodiment of the invention. There are generally four main execution paths in the high level process 80: power-up 82, the executive loop 84, the power fail interrupt 86, and the PWM interrupt 88. FIGS. 5-6 depict the structure and flow of execution in accordance with several embodiments of the invention.

For power up 82 (e.g., upon applying power to the brushless motor system), the processor can check that it is functional by testing the RAM and ARINC receive UART. These tests are generally performed only during the power-up built-in-test (PBIT) because they would otherwise interfere with normal processing. After the self-verification test for functionality, the processor generally performs a number of initialization tasks and then enters the executive loop. These tasks can include initialization of all of the necessary variables and hardware including the watchdog timer, ARINC UARTs, SPI bus, control loops, and PWM sub-systems.

The executive loop 84 generally executes those tasks that are to be performed in an orderly, consistent rate that are not critical to the motor control functions. These can include verification of valid message blocks received via ARINC 429 and the SPI bus, coordination and setting of proper commanded modes and values, transmission of ARINC labels and continuous built-in-test (BIT). The loop can execute once every 0.25 milliseconds, or at a rate of 4 kHz. Because ARINC 429 labels are to be sent at 100 times per second in some embodiments, a particular label generally needs to be processed at every 40th execution of the executive loop. The executive loop logical switch statement can have 40 cases. This ensures the data transmitted has as low a latency as possible. After each case is performed, the watchdog timer is serviced. Then for the remainder of available time until the 0.25 millisecond timer expires, the validity of the program in flash is checked by generating and checking a cyclic redundancy check (CRC).

The third major execution path, power fail interrupt 86, can be initiated upon removal of power from the actuator. An interrupt to detect the loss of input power can stop execution of the executive loop 84, the PWM interrupt 88, and then disengage the clutch. Finally, to notify associated equipment of the loss of power, an ARINC 429 Maintenance Label is sent with a power fail indication. From this point the execution of the program will generally halt. If the power interrupt was temporary, the watchdog timer will reset the processor and proceed through the power-up sequence again.

The primary motor control tasks or interrupts 88 performed by the process generally have consistent timing and take priority over other tasks. The control tasks can be structured to operate in a 40 kHz PWM interrupt. The control loops generally complete calculations for re-loading the PWM duty cycle before the end of each period. During each PWM period, the position can be calculated and the current control loop can be processed to set the commutation state and duty cycle. The output mode of the actuator (e.g., Torque, Position, or Rate) is also regulated in a control loop, but generally runs at a 10 kHz rate. Two other tasks are generally performed within the PWM 40 kHz interrupt to maintain particular timing margins. These tasks can include incrementing the 40 kHz timer for the executive loop, and checking the loading and unloading of the SPI registers.

FIG. 6 is a flowchart illustrating a process (executive loop) 84 for controlling a brushless motor system in accordance with one embodiment of the invention. The operation of the executive loop process 84 can be described from an initial start-up point. The flight computer (not shown) sends an ARINC 429 message to the brushless motor control system. Each DSP has access to the ARINC message. In block 102, the process reads four bytes of data from the ARINC 429 UART data buffer register. The process can check the validity of the received label, put the data into a temporary command block, check the CRC and set the command block status. The process, if the transmit queue is not empty, can write four bytes of data from the message transmit queue at the tail end onto the ARINC 429 UART transmit buffer register. The process can de-queue the receiver queue, validate command data and monitor data. If the command data is valid, the process extracts the commanded mode type and commanded value. The process can then set the command value threshold and range base on the commanded mode. If the monitor data is valid, the process can update the torque limit.

In block 104, the process builds an SPI message block. For the SPI slave, the process can also put the message on the transmit FIFO and reset the transmitter and receiver FIFOs. In block 106, the process performs the mid-value select based on the received commanded mode, a filtered onside commanded value, a cross side commanded value and a compensated position.

In some embodiments, blocks 102, 104 and 106 can be run consecutively. For example, the first time through the executive loop Case 0, or block 108, is executed, The next time through the executive loop Case 1, block 110, is executed. The tenth time through the executive loop the “Process CBIT” block is executed. On the eleventh time through the executive loop, block 108 can be repeated and the cycle can continue until each block is executed a total of four times.

After each of the case blocks has been executed, the process executes block 116 which services the watchdog timer. In block 118, the process calculates and checks the CRC. In block 120, the process determines if the total executive loop time elapsed is equal, or greater than, to 0.25 milliseconds (ms). If it is shorter then 0.25 ms, a wait loop is executed until 0.25 ms is reached. Once the 0.25 ms time has elapsed, the process loops back to the start of the executive loop.

In some embodiments, not all of the actions described in the process are executed. In other embodiments, the actions are performed in a different order than illustrated in the flow chart. In some embodiments, some actions are performed simultaneously. In some embodiments, the process performs additional actions providing other functionality.

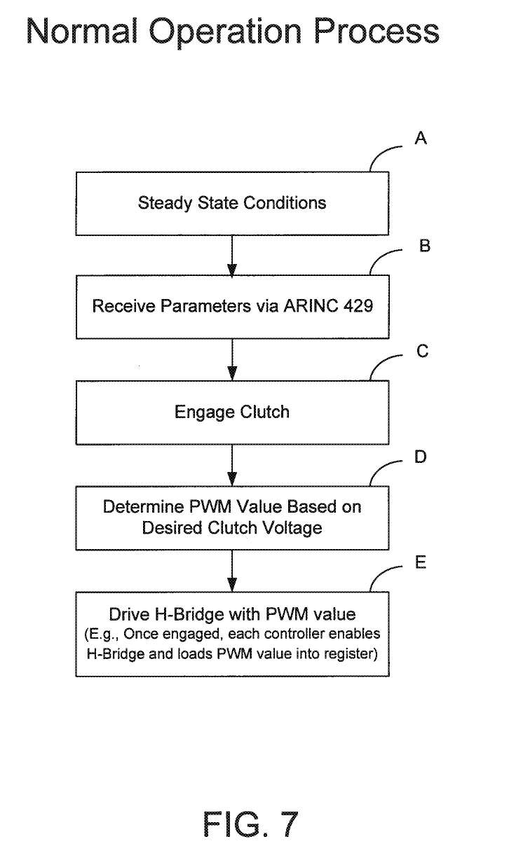

FIG. 7 is a flowchart illustrating a sequence of exemplary operations of a brushless motor control system in accordance with one embodiment of the invention. The sequence or process begins by achieving steady state conditions (A). The process then receives (B) parameters via ARINC 429. The process then engages (C) the clutch. The process then determines (D) a PWM value based on a desired clutch voltage, which is either provided by the flight computer via ARINC 429 or derived from a parameter provided from the flight computer. The process then drives (E) the H-Bridge with the PWM value. Once engaged, each controller enables the corresponding H-Bridge and loads the PWM value into a register which outputs PWM value to the respective H-Bridge driver (see FIG. 1).

In some embodiments, not all of the actions described in the process are executed. In other embodiments, the actions are performed in a different order than illustrated in the flow chart. In some embodiments, some actions are performed simultaneously. In some embodiments, the process performs additional actions providing other functionality.

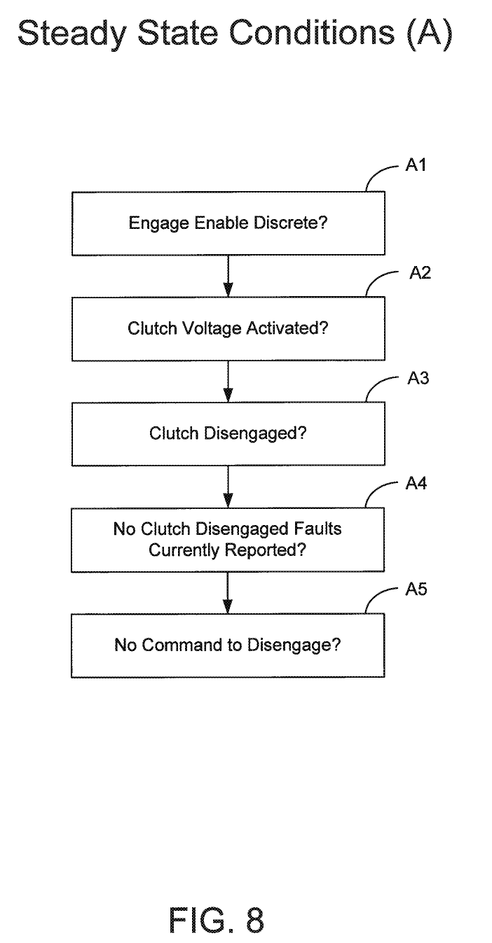

FIG. 8 is a flowchart illustrating steady state conditions (A) for a brushless motor control system in accordance with the operational sequence of FIG. 7. A sequence of inputs and conditions are checked to confirm operation at a steady state. In some embodiments, these inputs and conditions are necessary to engage the clutch. The sequence includes checking on the Engage Enable Discrete (A1) and Clutch Voltage (A2) inputs which are supplied to the servo via the flight control system. The Clutch Voltage should generally be above a preselected low tolerance and the Engage Enable Discrete can be tied high for proper operation. Other conditions for steady state include Clutch Disengaged (A3) for two execution periods prior to reengagement, No Clutch Disengage Faults (A4) being reported and the servo is not Commanded (A5) to Disengage via ARINC 429. The Clutch Disengaged check (A3) ensures the clutch is fully mechanically disengaged before re-engagement is performed. The No Clutch Disengage Faults (A4) check prevents an engagement while a fault condition exists. An example of a fault condition would be an SPI data fault indicating that the onside controller's checksum of the SPI data block does not match the transmitting controller's checksum. In such case, a invalid message has been received and is discarded. The No Command to Disengage check (A5) confirms that the Disengage Command generally takes priority over an Engage Command.

In some embodiments, not all of the actions described in the process are executed. In other embodiments, the actions are performed in a different order than illustrated in the flow chart. In some embodiments, some actions are performed simultaneously. In some embodiments, the process performs additional actions providing other functionality.

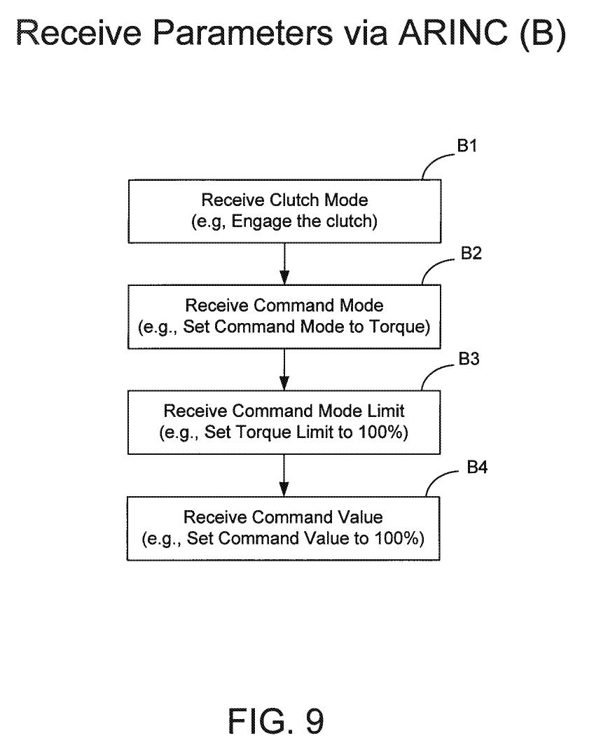

FIG. 9 is a flowchart illustrating a process (B) for receiving parameters via ARINC for a brushless motor control system in accordance with the operational sequence of FIG. 7. The process can begin by receiving (B1) a clutch mode instruction. For example, a clutch mode instruction could be a command to engage the clutch. The process can receive (B2) a command mode, such as, for example, setting the command mode to torque. The process can receive (B3) a command mode torque limit, such as, for example, setting a torque limit to 100 percent. The process can also receive (B4) a command value, such as, for example, setting the command value to 100 percent.

The inputs needed from the flight control system prior to operation can be received or calculated. These inputs can include the Command Mode, Command Value, Torque Limit and Engage Command which are communicated to the servo via ARINC 429 messages. The Command Value is the onside input into the Mid-Value Select function. The Mid-Value Select output, Desired Command Value, becomes an input into an error calculation used to determine the difference between the Desired Command Value and the actual motor state. For example, if the Command Mode is Position and Desired Command Value is 100 degrees, and the current state of the motor is at 0 degrees, the absolute value of the position error becomes 100 degrees. The motor is driven in a manner to achieve a position error of 0. A Torque Limit is used in conjunction with the Desired Command Value to determine the PWM duty cycle used to control the H-bridge. The Torque Limit is used in the control loop to limit the amount of torque needed to achieve the Desired Command Value.

In some embodiments, not all of the actions described in the process are executed. In other embodiments, the actions are performed in a different order than illustrated in the flow chart. In some embodiments, some actions are performed simultaneously. In some embodiments, the process performs additional actions providing other functionality.

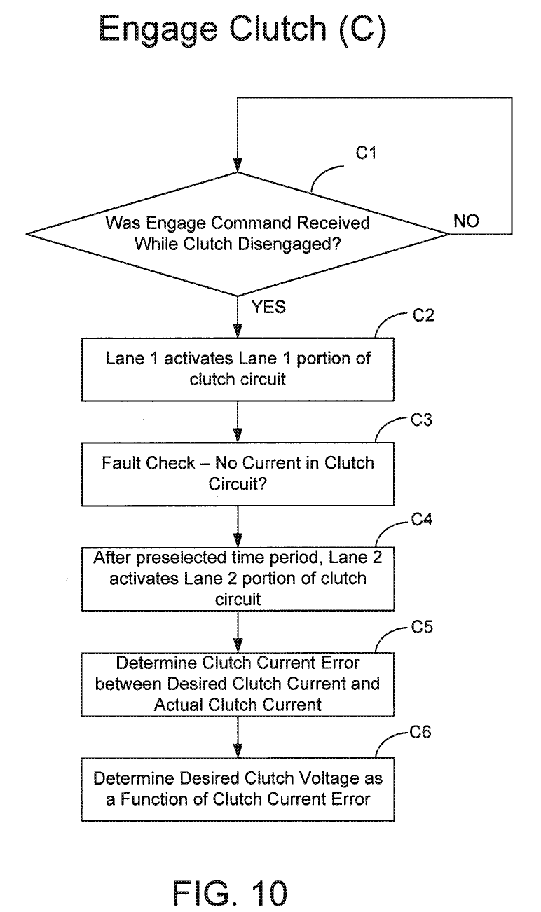

FIG. 10 is a flowchart illustrating a process (C) for engaging the clutch for a brushless motor control system in accordance with the operational sequence of FIG. 7. The process first determines whether an engage command was received (C1) while ensuring that the clutch was previously disengaged. If the condition is not met, the process waits until it is. If the condition is met, the lane one control circuitry activates (C2) lane one's portion of the clutch control circuit. The process then performs a fault check (C3) to ensure that there is no current in the clutch circuit. Fault checking is performed to ensure no current is flowing in the clutch circuit since Lane two has not turned on and there is not a complete electrical path. If the controller senses current flowing, a fault condition is flagged and the controller commands the clutch to disengage.

After a preselected time period, the lane two control circuitry activates lane two's portion of the clutch control circuit. This allows current to flow through the clutch coil, which produces a magnetic field overcoming the spring force of the clutch armature. As such, the clutch armature is pulled in and engages the clutch mechanically to the motor. The pulling in of the armature takes a specified amount of time and during this period current is allowed to exceed the steady state value. This pull in current value is higher due to the fact that the spring force and associated inertia must be overcome in order for movement of the armature to occur.

The process then determines (C5) the clutch current error as a function of the difference between a desired clutch current and the actual clutch current. The process then determines (C6) a desired clutch voltage as a function of the clutch current error. The desired voltage is used to determine a new PWM value needed to keep the clutch engaged. The PWM control of the clutch is performed by the lane one control circuitry. This PWM value is loaded into the PWM register of the controller.

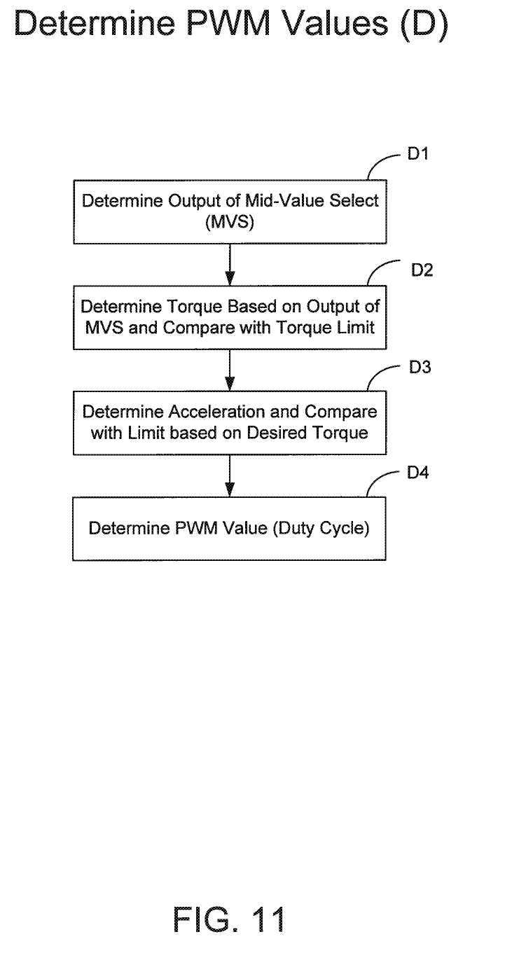

FIG. 11 is a flowchart illustrating a main process (D) for determining PWM values for a brushless motor control system in accordance with the operational sequence of FIG. 7. The process begins by determining (D1) an output of a mid-value select (MVS) function/algorithm. The process then determines (D2) torque based on the output of the MVS and compares it with a torque limit, which can be received in an ARINC message. The process also determines (D3) acceleration and compares it with a limit based on a desired torque determined in D2. The process then determines (D4) the appropriate PWM value needed to drive an H-Bridge driver and H-Bridge.

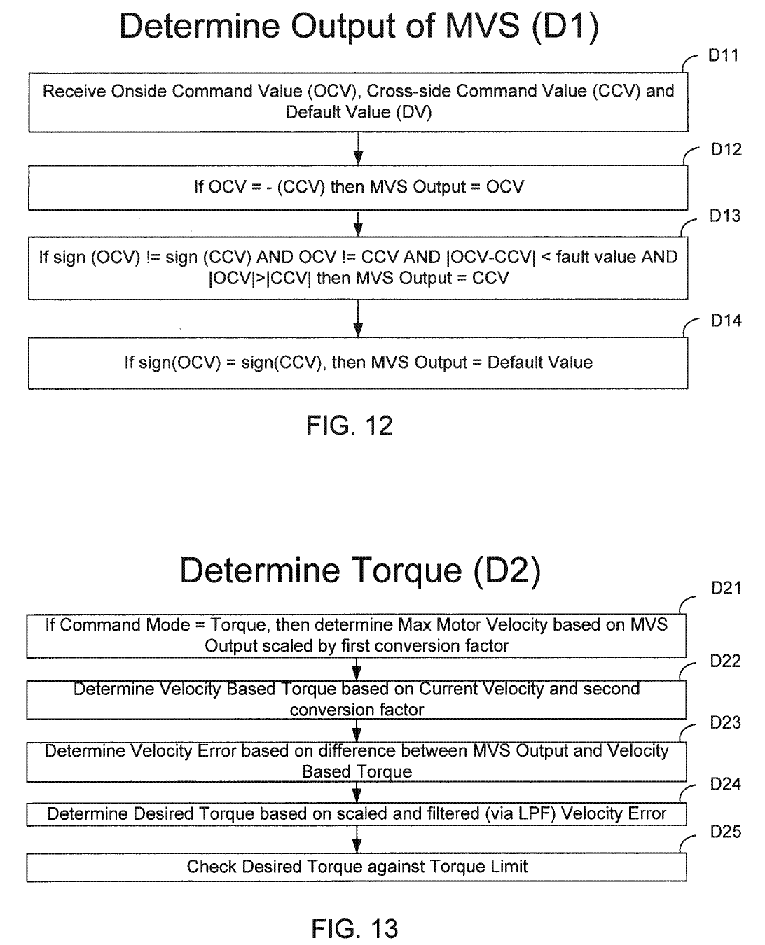

FIG. 12 is a flowchart illustrating a sub-process (D1) for determining an output of a mid-value select (MVS) algorithm of the process for determining PWM values illustrated in FIG. 11. The sub-process begins by receiving (D11) an onside command value (OCV), a cross-side command value (CCV) and a default value (DV). With respect to a particular DSP controller, the onside command value is the value sent to that controller from the flight computer and the cross-side command value is a negated form of the command value sent to the other DSP controller. If the onside and cross side command values are the same value and opposite signs (D12) then the mid value select output is set to the onside command value (OCV).

If the onside and cross side command values are different values and different signs, and the difference between these values is not large enough to flag a fault condition, and the absolute value of the onside command value is greater than the cross side command value (D13), then the output of the MVS is set to the cross side command value (CCV). If the sign of the onside command value and the cross side command value are the same (D14), then the output of the MVS is set to the default value. Since the cross side command value is negated before it is transmitted to other controller, if it is the same sign as the onside command value, lane 1 is being commanded to move in the opposite direction of lane 2. To prevent any potential fighting between the controllers, the desired command value is set to the default value (e.g., zero if the command mode is torque) for both controllers. For this example, the onside and cross side command values are equal and opposite in sign, and therefore sum of their values is zero. In such case, the output of the MVS is therefore set to the onside command value.

FIG. 13 is a flowchart illustrating a sub-process (D2) for determining torque in conjunction with the process for determining PWM values illustrated in FIG. 11. The sub-process first determines if the command mode is torque (D21), and, if so, the MVS output is scaled by a first conversion factor to determine a maximum motor velocity based on the MVS output. The sub-process then determines a velocity based torque (D22) using the motor's current velocity and a second conversion factor. The velocity based torque is limited by the maximum motor velocity. The sub-process then determines a velocity error (D23) based on a difference between the MVS output and the velocity based torque. This error signal can be scaled and sent through a low pass filter and the sub-process can determine a resultant desired torque (D24). The sub-process can check the resultant desired torque against a torque limit (D25) to confirm that it is within the limit.

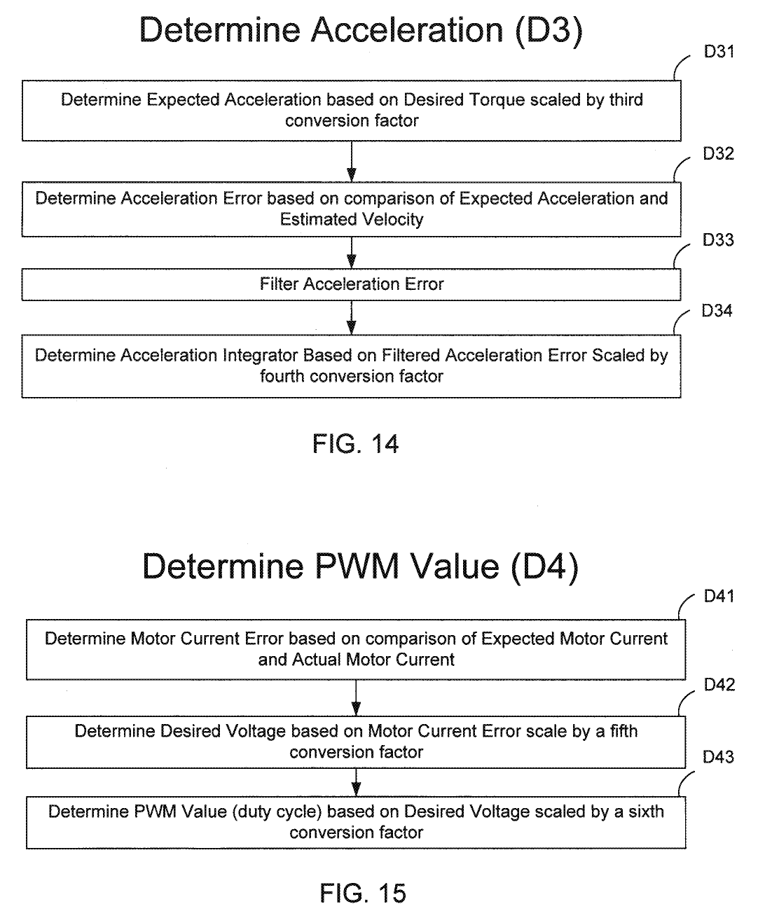

FIG. 14 is a flowchart illustrating a sub-process (D3) for determining acceleration in conjunction with the process for determining PWM values illustrated in FIG. 11. The sub-sub-process can determine an expected acceleration (D31) of the motor and motor current based on the resultant desired torque (from sub-process D2) scaled by a third conversion factor. The sub-process then determines an acceleration error (D32) based on a comparison of the expected acceleration and an estimated velocity. The sub-process then filters the acceleration error value (D33). The sub-process determines an acceleration integrator (D34) based on the filtered acceleration error scaled by a fourth conversion factor. The acceleration integrator is used to determine a desired velocity of the motor.

FIG. 15 is a flowchart illustrating a sub-process (D4) for determining a PWM value in conjunction with the process for determining PWM values illustrated in FIG. 11. The sub-sub-process determines a motor current error (D41) based on a comparison of an expected motor current and the actual motor current. The sub-process then determines a desired voltage (D42) based on the motor current error scaled by a fifth conversion factor. The sub-process then determines a PWM value (D43) or duty cycle to be applied to the motor based on the desired voltage scaled by a sixth conversion factor. The PWM value can be output to a stator winding via an H-Bridge and H-Bridge driver.

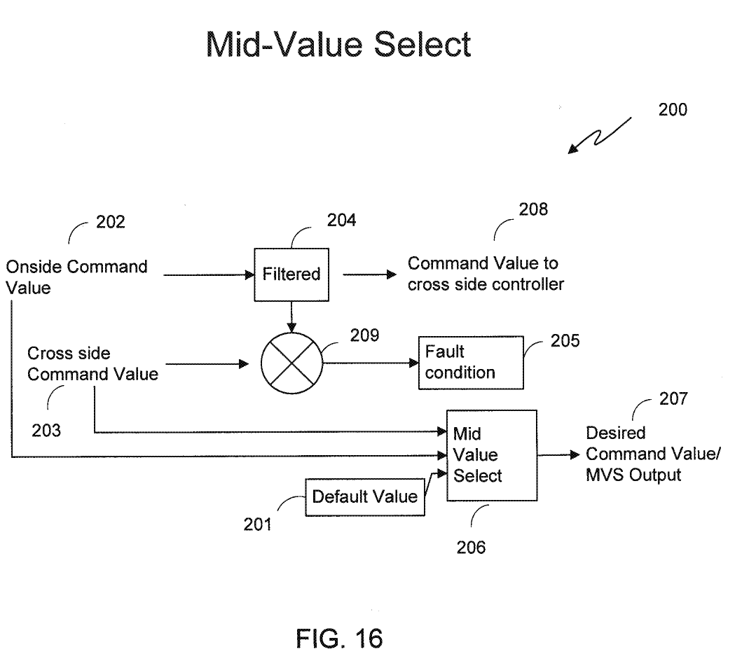

FIG. 16 is a schematic block diagram illustrating of a mid-value select system in accordance with one embodiment of the invention. To achieve a more robust system, an MVS system can be implemented to calculate the desired command value (MVS output) over transients, faults, or lags associated with the input values. Since the controller for each lane is generally from a different manufacturer, control processes are designed to account for processing timing differences between each controller and their respective lane. In addition, fault checking generally needs to be implemented. The fault checking process compares the command values for each lane to check if they are out of tolerance. If so, a software flag will be set. In several embodiments, if a preselected number of comparison flags occur in a preselected time period, the clutch is forced to disengage by the lane that detects the problem. In such case, any uncommanded motion is prevented. The MVS system of FIG. 16 helps to implement a number of these features.

The MVS system 200 includes at least three input values: a Default Value 201, an Onside Command Value 202 and a Cross Side Command Value 202. The Default Value 201 is determined based on the commanded mode of operation for the smart servo. For example, if the commanded mode is a torque mode, the default value is 0. The Onside Command Value 202 is the command value sent to the servo over the ARINC 429 bus for the onside controller and received by the onside controller. The Cross Side Command Value 203 is the command value sent to the servo over the ARINC 429 bus for the cross side controller and is received by the cross lane controller. The Cross Side Command Value is communicated to the controller on the opposite lane via the SPI bus in a negated form. This functionality is common to each controller.

Referring now to FIG. 16, both the Onside Command Value 202 and Cross Side Command Value 203 are passed through a low pass filter 204 thereby averaging their values over a time period. The values are then summed 209 together to find a difference between the values. This is possible because the Cross Side Command Value 203 is negated before it is transmitted over SPI. It is at this point that the software flag can be set (205) if the difference between the values is out of tolerance. This output of the mid value select (207) become the desired command value for both lanes. The command value for the cross-side controller 208 can be sent to the other controller over the SPI bus.

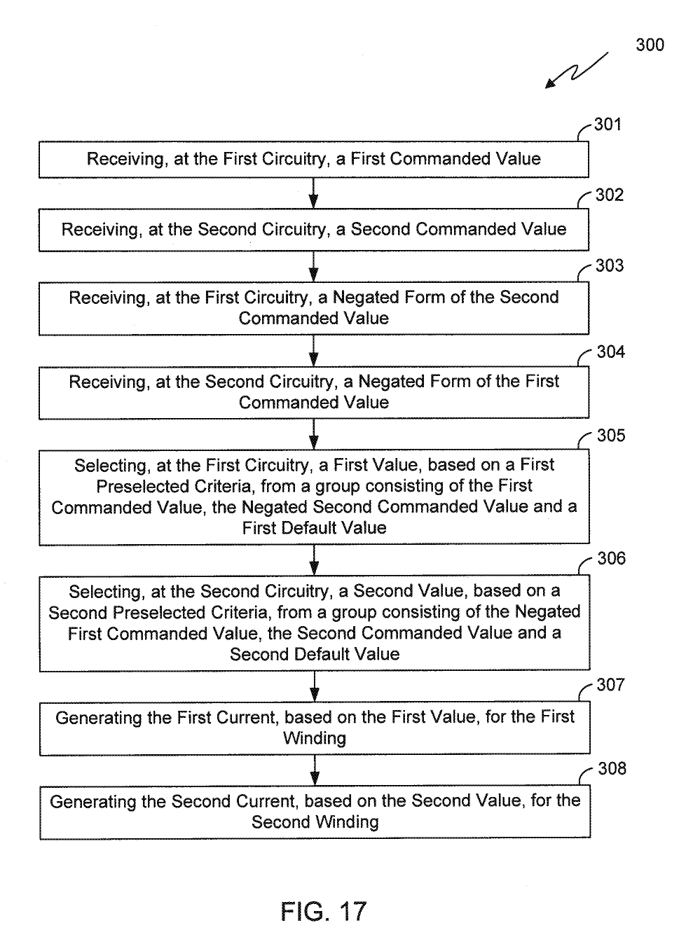

FIG. 17 is a flowchart illustrating a process 300 for substantially independent control of a two phase brushless motor with first circuitry controlling a first winding of the motor and second circuitry controlling a second winding of the motor in accordance with one embodiment of the invention. In a number of embodiments, the process 300 is used to control a two phase brushless motor system including a rotor, a stator having a first winding and a second winding, a first control circuitry for controlling a movement of the rotor by providing a first current to the first winding, and a second control circuitry for controlling the movement of the rotor by providing a second current to the second winding.

The process receives (301), at the first circuitry, a first commanded value. In one embodiment, the first circuitry corresponds to the Lane 1 control circuitry. The process receives (302), at the second circuitry, a second commanded value. In one embodiment, the second circuitry corresponds to the Lane 2 control circuitry. The process receives (303), at the first circuitry, a negated form of the second commanded value. The process receives (304), at the second circuitry, a negated form of the first commanded value. The process selects (305), at the first circuitry, a first value, based on a first preselected criteria, from a group consisting of the first commanded value, the negated second commanded value and a first default value. The process selects (306), at the second circuitry, a second value, based on a second preselected criteria, from a group consisting of the negated first commanded value, the second commanded value and a second default value. The process generates (307) the first current, based on the first value, for the first winding. The process generates (308) the second current, based on the second value, for the second winding.

In some embodiments, not all of the actions described in the process are executed. In other embodiments, the actions are performed in a different order than illustrated in the flow chart. In some embodiments, some actions are performed simultaneously. In some embodiments, the process performs additional actions providing other functionality.

Embodiments of the present invention present a number of benefits. For example, there are significant benefits to the present two phase motor design versus a three phase motor design. The two phase motor is well suited for dual lane control, provides slotless construction to eliminate cogging, and provides comparable torque to a three phase slotted motor. The two phase motor also lends itself more easily to dual control, enabling redundant and fail-passive control, than does a three phase motor.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

What is claimed is:

1. A fail passive system for controlling two phase brushless motors, the system comprising:
a two phase brushless motor comprising:
a stator;
a rotor;
a first winding electromagnetically coupled to the rotor; and
a second winding electromagnetically coupled to the rotor;
first control circuitry coupled to the first winding, the first control circuitry configured to provide a first current to the first winding;
second control circuitry coupled to the second winding, the second control circuitry to provide a second current to the second winding;
wherein the first control circuitry is configured to receive a first commanded value from an external control circuit;
wherein the second control circuitry is configured to receive a second commanded value from the external control circuit;
wherein the first control circuitry is configured to receive a negated form of the second commanded value from the second circuitry;
wherein the second control circuitry is configured to receive a negated form of the first commanded value from the first circuitry; and
wherein the first control circuitry and the second control circuitry are configured to concurrently control a movement of the rotor.

2. The system of claim 1:
wherein the first control circuitry is configured to compensate for a failure in the second control circuitry; and
wherein the second control circuitry is configured to compensate for a failure in the first control circuitry.

3. The system of claim 1, further comprising:
a first position sensor configured to detect a position of the rotor;
a second position sensor configured to detect the position of the rotor;
wherein the first position sensor is coupled to the first control circuitry; and
wherein the second position sensor is coupled to the second control circuitry.

4. The system of claim 1:
wherein the first control circuitry comprises a digital signal processor of a first type;
wherein the second control circuitry comprises a digital signal processor of a second type; and
wherein the first type and the second type are different.

5. The system of claim 1:
wherein the first winding comprises four coils in series;
wherein the second winding comprises four coils in series;
wherein each of the coils of the first winding is wound in a direction opposite of a direction of an adjacent coil of the first winding; and
wherein each of the coils of the second winding is wound in a direction opposite of a direction of an adjacent coil of the second winding.

6. The system of claim 5, wherein a direction of a magnetic field of a first coil of the coils of the first winding and second winding is orthogonal to a direction of a magnetic field of a second coil of the coils of the first winding and second winding, wherein the first coil is adjacent to the second coil.

7. The system of claim 5, wherein the rotor is a four pole rotor having a substantially square cross section.

8. The system of claim 5:
wherein the stator comprises a ring shaped cross section having eight sections;
wherein a first section of the eight sections includes windings of two of the coils of the first winding, and a second section, adjacent to the first section, includes windings of two of the coils of the second winding.

9. The system of claim 8, wherein the ring shaped cross section of the stator surrounds the square cross section of the rotor.

10. The system of claim 1:
wherein the first control circuitry is configured to select, based on a first preselected criteria, a first value from a group consisting of the first commanded value, the negated second commanded value and a first default value;
wherein the first control circuitry is configured to use the first value to generate the first current for the first winding;
wherein the second control circuitry is configured to select, based on a second preselected criteria, a second value from a group consisting of the negated first commanded value, the second commanded value and a second default value; and
wherein the second control circuitry is configured to use the second value to generate a current to be provided to the second winding.

11. The system of claim 10:
wherein the first control circuitry is configured to calculate a desired torque based on the first value;
wherein the first control circuitry is configured to compare the desired torque based on the first value with a first torque limit;
wherein the second control circuitry is configured to calculate a desired torque based on the second value; and
wherein the second control circuitry is configured to compare the desired torque based on the second value with a second torque limit.

12. The system of claim 10:
wherein the first control circuitry is configured to calculate an expected acceleration based on the first value;
wherein the first control circuitry is configured to compare the expected acceleration based on the first value with a first acceleration limit;
wherein the second control circuitry is configured to calculate an expected acceleration based on the second value; and
wherein the second control circuitry is configured to compare the expected acceleration based on the second value with a second acceleration limit.

13. A method for controlling a two phase brushless motor system comprising a rotor, a stator having a first winding and a second winding, a first control circuitry for controlling a movement of the rotor by providing a first current to the first winding, and a second control circuitry for controlling the movement of the rotor by providing a second current to the second winding, the method comprising:
receiving, at the first circuitry, a first commanded value;
receiving, at the second circuitry, a second commanded value;
receiving, at the first circuitry, a negated form of the second commanded value;
receiving, at the second circuitry, a negated form of the first commanded value;
selecting, at the first circuitry, a first value, based on a first preselected criteria, from a group consisting of the first commanded value, the negated second commanded value and a first default value;
selecting, at the second circuitry, a second value, based on a second preselected criteria, from a group consisting of the negated first commanded value, the second commanded value and a second default value;
generating the first current, based on the first value, for the first winding;
generating the second current, based on the second value, for the second winding.

14. The method of claim 13, further comprising:
compensating, at the first circuitry, for a failure in the second circuitry; and
compensating, at the second circuitry, for a failure in the first circuitry.

15. The method of claim 13, further comprising:
detecting, at a first position sensor, a position of the rotor;
detecting, at a second position sensor, a position of the rotor;
receiving, at the first circuitry, position information from the first position sensor; and
receiving, at the second circuitry, position information from the second position sensor.

16. The method of claim 13:
wherein the first circuitry comprises a digital signal processor of a first type;
wherein the second circuitry comprises a digital signal processor of a second type; and
wherein the first type and the second type are different.

17. The method of claim 13:
wherein the first winding comprises four coils in series;
wherein the second winding comprises four coils in series;
wherein each of the coils of the first winding is wound in a direction opposite of a direction of an adjacent coil of the first winding; and
wherein each of the coils of the second winding is wound in a direction opposite of a direction of an adjacent coil of the second winding.

18. The method of claim 17, wherein a direction of a magnetic field of a first coil of the coils of the first winding and second winding is orthogonal to a direction of a magnetic field of a second coil of the coils of the first winding and second winding, wherein the first coil is adjacent to the second coil.

19. The method of claim 17, wherein the rotor is a four pole rotor having a substantially square cross section.

20. The method of claim 17:
wherein the stator comprises a ring shaped cross section having eight sections;
wherein a first section of the eight sections includes windings of two of the coils of the first winding, and a second section, adjacent to the first section, includes windings of two of the coils of the second winding.

21. The method of claim 20, wherein the ring shaped cross section of the stator surrounds the square cross section of the rotor.

22. The method of claim 13, further comprising:
calculating, at the first circuitry, a desired torque based on the first value;
comparing, at the first circuitry, the desired torque based on the first value with a first torque limit;
calculating, at the second circuitry, a desired torque based on the second value; and
comparing, at the second circuitry, the desired torque based on the second value with a second torque limit.

23. The method of claim 13, further comprising:
calculating, at the first circuitry, an expected acceleration based on the first value;
comparing, at the first circuitry, the expected acceleration based on the first value with a first acceleration limit;
calculating, at the second circuitry, an expected acceleration based on the second value; and
comparing, at the second circuitry, the expected acceleration based on the second value with a second acceleration limit.
